(19) United States
(12) Patent Application Publication
(10) Pub. No.: US 2007/0090570 A1
(43) Pub. Date: Apr. 26, 2007

(54) METHOD AND APPARATUS FOR MOLDING AN INTERLOCKING TAB IN A SINGLE MOLDING AND FORMATTING STEP

(76) Inventors: Monty Cochran, Cumming, GA (US); Wayne Moore, Frankfort, KY (US)

Correspondence Address: BLACKWELL SANDERS PEPER MARTIN LLP, 4801 Main Street, Suite 1000, KANSAS CITY, MO, 64112, US

(21) Appl. No.: 11/163,661

(22) Filed: Oct. 26, 2005

(51) Int. Cl. B29C 45/00

(52) U.S. Cl. 264/318; 425/577; 425/542; 425/DIG. 58

(57) ABSTRACT

The present invention relates to a method and apparatus for molding plastic articles. More specifically, the present invention is directed to a staged sequentially separated apparatus for injection molding of plastic panels having a flap or tab molded therewith in a single molding and forming step. The present invention provides, among other things, a method and an apparatus for forming an injection molded part with an undercut, the undercut lying generally in a plane of a major portion of the part, the undercut having an open elongate opening and being positioned between an elongate integrally molded tongue and panel. The apparatus comprising a first mold half with a first mold cavity defining surface, a second mold half with a second mold cavity defining surface, a tongue member carried by the second mold half and projecting into a mold cavity. The tongue member having generally opposing facing surfaces spaced from the first and second mold cavity surfaces for forming opposite face of a molded part undercut. The apparatus also comprising means to selectively effect movement of the transverse mold insert relative to at least a portion of the remainder of the second mold half.

### BACKGROUND OF THE INVENTION

The present invention relates to a method and apparatus for molding plastic articles. More specifically, the present invention is directed to a staged sequentially separated apparatus for injection molding of plastic panels having a flap or tab molded therewith in a single molding and forming step.

Injection molding techniques of plastic materials is well known in the art. Molding techniques such as this are suitable for forming a wide variety of parts at relatively low costs. Injection molding is particularly advantageous for high speed forming large quantities of discrete parts from thermo-plastic resins/polymers. Certain features of a particular part sometimes utilize the application of some unique molding techniques. Ordinarily, an injection molding apparatus for manufacture of a molded part comprises a mold made of steel or other metallic substance. The molds usually have two mold halves which move relative to one another in generally opposite directions which limits molded part designs.

The mold contains a mold cavity that is configured to match the part that is to be molded. The mold is typically characterized by a stationary molding half, and a movable molding half. The mold is openable or separable at a parting line so that the molded part can be removed from the mold cavity. A polymer based material such as polystyrene or the like is injected into the mold when the mold is closed. After the material has been cooled or set, the mold is opened and the molded part is ejected or removed from the mold. In some machines, both halves of the mold are moveable. The process is then repeated to form subsequent parts.

One skilled in the art recognizes that the mold halves are clamped and tightly held together in order for the molded part to be properly formed.

Certain types of molded parts have protrusions or edges, which are formed with an undercut in the part. Forming an undercut in a part generally requires that the molten material surrounds a tongue or other mold insert. As in all molding processes, the molded part with an undercut needs to be released from the mold for subsequent use. Any one of a variety of mechanisms may be employed for releasing the molded part from the mold parts forming such undercuts. Systems and techniques heretofore utilized are not suitable for molding parts having an undercut to form a relatively thin flap or tab.

A simulated cedar shake siding panel, which utilizes a locking flap to interengage a locking lip located on a second panel, has been difficult to form utilizing traditional techniques because of the dimensional specifications of the tab and undercut. As such, a part like this is usually formed in a multi-step process. In other words a first process creates a first part, then an additional one or more processes, are employed, either locally or at a remote location, to add or form the tab to complete the part.

A cedar shake siding panel 10 such as shown in FIGS. 1 and 2 is traditionally formed in a multi-step manufacturing process. In its finished form the panel 10 has a nail hem 22, a tab 24, a top surface 26, and laterally extending rows 27A, 27B of simulated wood or wood grain shingles 14. A plurality of elongate slots 23 are provided in the nail hem 22, for attaching the panel to a structure such as a wall.

The first prior art manufacturing process is best described with reference to FIG. 3A, in which a strip 20 is molded as part of the panel 10 having opposite ends 9, 11. The strip 20 includes openings 28 and a row of bosses 30 located on the strip 20, and a folding area 32 located therebetween. The strip 20 also includes a tab forming portion 23. The tab forming portion 23, strip 20, openings 28, bosses 30 and folding area 32 extend along the panel 10 between the opposite ends 9, 11. Prior to the implementation of a second forming process or as a part thereof, the strip 20 is folded along the folding 32 in the direction shown A in FIG. 3A. The location of the fold and the extent of the fold is such that the bosses 30 fit inside the openings 28, and a tab 24 which extends downwardly is formed and spaced from the strip 20, as shown in FIG. 3B forming an open sided groove 25 therebetween. Irrespective of when the fold is made, the second process involves joining the opposing surfaces of the strip 20. As would be understood by one skilled in the art, such joining may be accomplished by heat, ultrasonic welding, mechanical interlude, adhesion or some other means. The result of the joint is an integrated structure with a tab 24 and groove 25 as shown in FIG. 3B.

Generally and at best, the step in the manufacturing process for folding and joining the opposed surfaces of the strip 20 is performed in a post injection molding step and on a separate production line using additional equipment. More typically, the folding and the joining step in particular, occurs at a different facility, such as when the joining process involves ultrasonic welding of the part.

In either case, and particularly in the situation where the parts are transported to a different facility, a number of issues that impact the cost and quality of the final product arise. For example, there are issues relating to handling, which can include movement or shipping of the parts, timing and frequency of such movements, and so on. The logistics involved in handling have an associated additional cost. Even further, there are the costs and other issues associated with the operations at the welding facility. Further still there are some duplicative efforts in the process as a whole such, such as in the packaging of the parts. Parts are packaged after the initial molding process for transportation to the welding facility and then again for final shipment of the completed panel 10.

There is therefore a need for a system and method that provides a simplified manufacturing process, wherein some cost savings, quality control and efficiencies can be achieved without adversely impacting the quality of the end product. Even further there is a need for a system and method that eliminates the need for the secondary and separate folding and welding operation described above while still meeting the specifications of the molded part. The present invention addresses this need and overcomes the limitations of the prior art.

### SUMMARY OF THE INVENTION

To address these and other concerns, the present invention provides, among other things, a

method and an apparatus for forming in a single molding step in a mold, a part having an undercut, and at least one longitudinally extending groove in the general plane of the part, the undercut and groove presenting motion restricting surfaces. The apparatus comprising multiple moveable mold elements, the moveable mold elements adapted to fit together to define a cavity to form the part, the moveable mold elements adapted to be moved in a particular sequence to free the molded part. The apparatus also comprising means for releasing or ejecting the part from the mold. The multiple moveable mold elements comprise, a first mold half having a first mold cavity defining surface to match a portion of one side of the part, a slide having an overhang portion and a second mold half having a second mold cavity defining surface. Also included is an elongate transverse mold insert having a distal end that defines a portion of the mold cavity. The second mold half having a tongue with a top surface and a lower surface for forming the undercut in the molded part. The tongue protruding into the mold cavity. The mold cavity is at least partially defined by the first cavity defining surface of the first mold half, the overhang portion of the slide, along with the surface of mold insert, the second mold cavity defining surface and the surface of the tongue.

### BRIEF DESCRIPTION OF THE DRAWINGS

The present invention is further described with reference to the accompanying drawings, which show various constructions and implementations of the present invention. However, it should be noted that the invention as disclosed in the accompanying drawings is illustrated by way of example only. The various elements and combinations of elements described below and illustrated in the drawings can be arranged and organized differently to result in constructions which are still within the spirit and scope of the present invention.

FIG. 1 is a front elevation view of an exemplary plastic siding panel that may be formed by the system and method of the present invention;

FIG. 2 is a left side view of the panel of FIG. 1;

FIG. 3A is a fragmentary side view of the flap section of a siding panel prior to the folding and welding of the flap; (PRIOR ART)

FIG. 3B is a fragmentary side view of the flap section of a siding panel after the folding and welding of the flap; (PRIOR ART)

FIG. 4 is an illustrative mold, for forming the panel of FIG. 1 in accordance with the present invention, shown in the closed position;

FIG. 5 is the mold of FIG. 4 shown after a first mold opening step;

FIG. 6 is the mold of FIG. 5 shown with a partial second mold opening step and illustrating the flexing of the flap portion of the molded part;

FIG. 7 is the mold of FIG. 6 shown with a completed second mold opening step, wherein the second mold half is separated from the part; and

FIG. 8 is the mold of FIG. 7 illustrating a retracted slide and the ejected part.

### DETAILED DESCRIPTION

The present invention is directed to a tooling system and method for forming a molded plastic part having an undercut and exposing a flap or as in the embodiment described herein, an interlock feature or tab for a simulated wood shingle siding panel. The undercut is oriented such that it will lock the part to one or more components of the mold if the mold halves were to open in a simple unidirectional opening motion. More specifically, the present invention pertains to a mold or tooling construction and molding process that allows a tab or interlock feature, to be molded and formed concurrent with the molding of the part in a one step forming process using molding. The invention eliminates the requirement to perform secondary forming steps such as folding and ultrasonic welding, when creating parts of the type described.

In an embodiment, the present invention utilizes aspects of formed part material properties and a retaining slide to mold an interlock tab in place. The slide insert is built into a mold construction and allows pulling force to be applied to wall members, to mold the interlock in place. The invention is hereinafter described with reference to the accompanying drawing Figures and one or more exemplary embodiments. It should be understood that the description herein is for illustrative purposes only and is in no way intended to limit or otherwise confine the invention to the specific embodiment or disclosed steps, procedures or components.

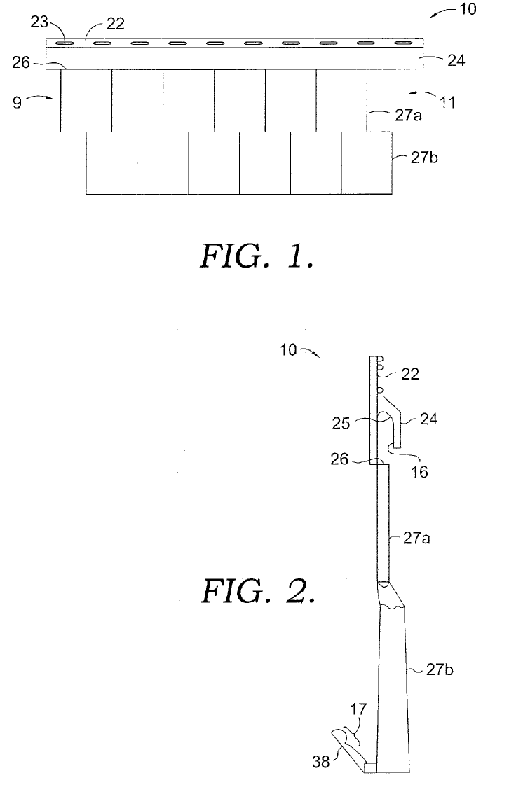

Referring to the drawings, there is shown in FIG. 1, a plastic (polymeric) panel 10 for use in covering a portion of a building exterior e.g. a sidewall. A plurality of such panels 10 are typically used to cover an appropriate portion of the building exterior. The plurality of panels 10 are designed to fit, or otherwise work, together. As such, the panels 10 are designed with a means to inter-engage one another and means to facilitate attachment to the building. The panels may also be designed to meet other aesthetic and functional needs. For example, the panel 10 may include laterally extending and substantially parallel rows of patterns/embossed designs formed to mimic the appearance of wood shingles or shakes 14. The panel 10 may also be designed to attach to, or be attachable by a second and similar panel 12. The means for inter-engaging the panels 10, 12 is best described with reference to the side view of the panel 10, illustrated in FIG. 2.

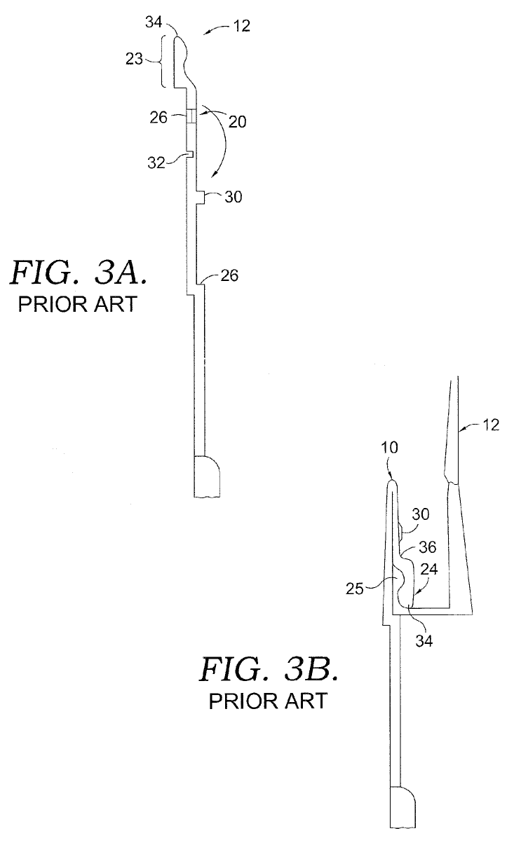

As shown in FIG. 2, panel 10 includes among other things, an upper row 27A and lower row 27B of simulated shingles 14 a tab 24 and a flange 38. Multiple panels 10 are usually utilized to cover the exterior of a building. So, for example, when a first panel 10 is installed, a second panel 12 is installed above it and the sequence is repeated until the building exterior is covered. The panel 10 may have a continuous tab 24 and groove 25 extending the length of the panel between opposite ends 9, 11. Alternatively, there could be multiple tabs 24 and groove 25 spaced along length of the panel 10. At least one tab 24 of the first panel 10 is engaged by at least one flange 38 of the second panel 12, such as illustrated in FIG. 3B. Returning to FIG. 2, as would be understood by one skilled in the art there are a variety of surface contour(s) 16 that may be present on the tab 24 with opposing contour(s) 17 on the flange 38 such as to arrest or restrict relative vertical motion of the panels 10,12.

The molding of an article having an undercut such as panel 10 described herein as having a tab 24, nail hem 22 and other features, is the subject of the system and method of the present invention. The described embodiment of the present invention is directed to the making of panel 10 in an injection molding process. As with any other plastic articles formed by a method of injection molding, the present invention also includes a mold. The mold of the present invention enables the molding of a panel 10 with the tab 24 in a single forming process. Even further, the present invention facilitates the end result without the need for a secondary folding and joining step to form the tab 24. It should be understood that the present invention contemplates the elimination of the need for secondary processes, which may be employed to create a tab, or other such undercut forming member in the molding of any articles.

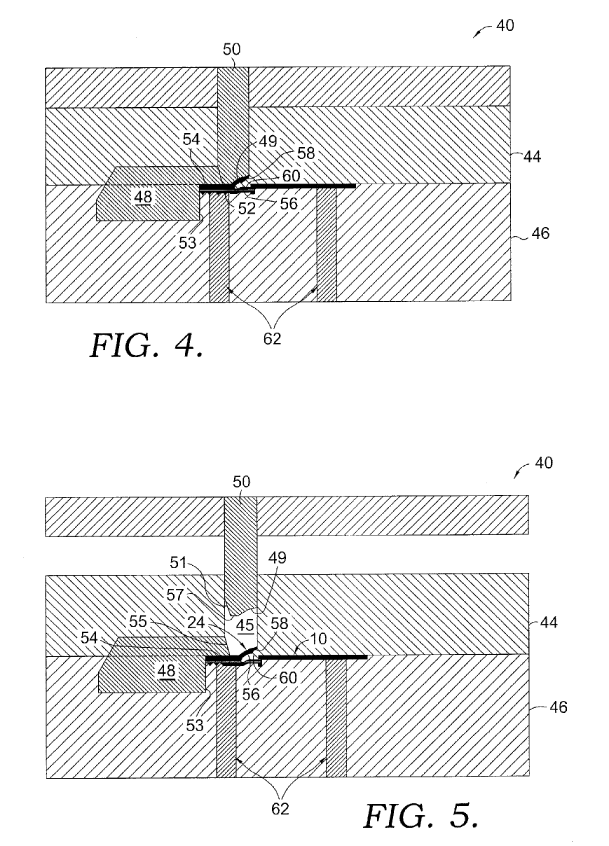

The mold assembly of the present invention is best described with reference to FIG. 4. FIG. 4 illustrates a mold assembly 40 for an injection mold apparatus that facilitates forming a panel 10 with a tab 24. The mold assembly 40 is depicted in the closed position in FIG. 4.

In an embodiment of the present invention, the mold assembly 40 includes a mold cavity 52, for receiving flowable or pressure formable material to form the panel 10, and ejectors 62 to eject the panel 10 from the cavity 52. The mold cavity 52 is partially defined by a first mold half 46, and a second mold half 44. A transverse mold insert 50 is part of the second mold half 44. The transverse mold insert 50 moves transverse to the parting line of the mold 40 and plane of the panel 10. A portion of the mold insert 50 in conjunction with a slide 48 and the first mold half 46, further define the mold cavity 52. The surfaces defining the mold cavity 52 define the particular configuration of the panel 10. For example, the second mold half 44 has contours and recesses that define one side of the panel 10. The surface of the mold cavity 52 can include various surface portions.

In the current embodiment, the slide 48 is designed with a wall 53, an overhang portion 54, having a sloped frontal surface 55. The overhang portion 54, is adjacent to and abuts the mold insert 50, and also further defines at least a portion of the cavity 52 in conjunction with the surface of the first mold half 46. The slide 48 is retained in a specific position over the cavity 52 by the second half mold 44 when the mold is closed. The second mold half 44 is fabricated with a tongue 56 having a first surface 58 and a second surface 60. The first surface 58 is shaped to form the desired contour(s) 16 of one side of the tab 24 and groove 25. The second surface 60 is shaped to form the opposing side of the groove 25. The mold insert 50 may have a beveled first surface 51 that co-acts and is adjacent to the sloped frontal surface 55 of the slide 48. The mold insert 50 may further have a molding surface constrained to and including a substantially planar surface 57 adjacent the beveled surface 51, and a second surface 49 adjacent the generally planar surface 57. The substantially planar surface 57 and the second shaped surface 49 are located on opposite sides of a distal end of the mold insert 50. The second surface 49 of the insert 50 opposes and overlies a tongue 56 of the second mold half 44. The second surface 49 defines the exterior or exposed portion of the tab 24. The second shaped surface 49 of insert 50 and the first surface 58 of the tapered tongue 56 define a region in the cavity 52 for the tab 24 to be formed.

Also illustrated in FIG. 4, are ejector pins 62 in a retracted or molding position, wherein the exposed ends of the ejector pins 62 form part of the mold cavity surface of the first mold half 46. In many installations it may be preferable to have the ends of the ejector pins 62 slightly recessed or slightly projecting with respect to the surface of the cavity 52. As would be recognized by those skilled in the art, any suitable number of mold elements or cores may be positioned to effect the desired mold form and the ejection of the part therein.

In the molding process, the cavity 52 is filled with material under pressure with the mold in the closed position as illustrated in FIG. 4 to form the panel 10. The elements used for feeding material into the cavity 52, as well as any elements required for heating the material etc., are not illustrated or described, in order to simplify the description. After a period of time sufficient for the formed panel 10 to cool and set as needed, the mold 40 is ready to be separated and the panel 10 ejected from the mold cavity 52. As would be understood by one skilled in the art, the forces exerted on the part during the mold separation process are controlled to avoid potential damage to the part. The present invention utilizes a multiple stage mold separation process to achieve this end.

In the first stage of the separation, mold insert 50 is removed from the second mold half 44 in a direction that is lateral to the opening and closing direction of the mold. The mold insert 50, extends into a recess 45 of the second mold half 44, and defines the outer surface of the tab 24. The second mold half 44 and the slide 48 remain in place over the rest of the cavity 52. Keeping the slide 48 and second mold half 44 in place during the initial mold opening causes the tab 24 to pull away from the stationary side of the mold, i.e. the first mold half 46. The completion of the first stage of separation is illustrated in FIG. 5. As is readily seen, the mold insert 50 is fully withdrawn.

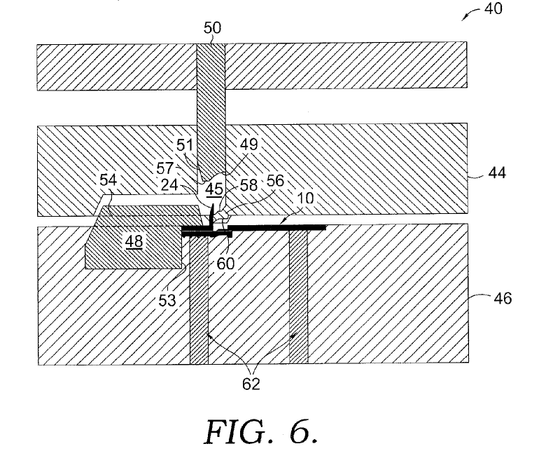

The second stage of separation is commenced by the movement of the second mold half 44 away from the first mold half 46. During the second stage, the tongue 56, which extends underneath the tab 24, simultaneously begins to flex the tab 24. In accordance with known methods in the art, the tab 24 is formed to have memory, thus enabling it to flex and return to a desired position. The tab 24 is flexed in a direction that is consistent with the movement of the second mold half 44 and towards the slide 48. The partial completion of the second stage of separation is illustrated in FIG. 6. As is readily seen, the flexed tab 24 provides a clearance that effects the separation of the second mold half 44 and the tongue 56, without appreciable deformation to the tab 24. The movement of the second mold half 44 continues until the tongue 56 clears the tab 24.

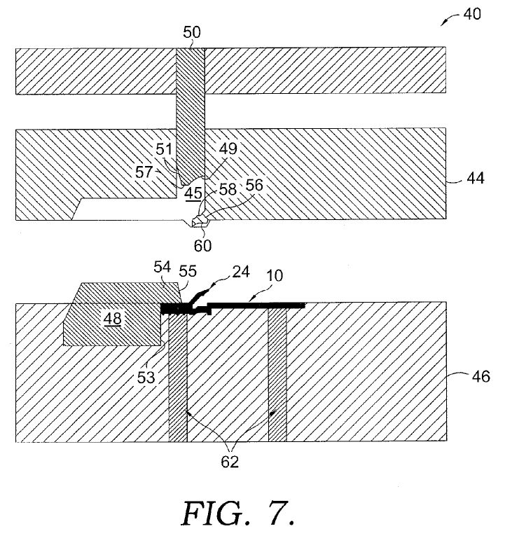

The completion of the second stage of separation is illustrated in FIG. 7. As is readily seen, the second mold half 44 is completely separated from the first mold half 46, and the tongue 56 has cleared the tab 24, thus allowing the tab 24 to return to a desired molded position. This allows the beginning of the final stage of mold and part separation.

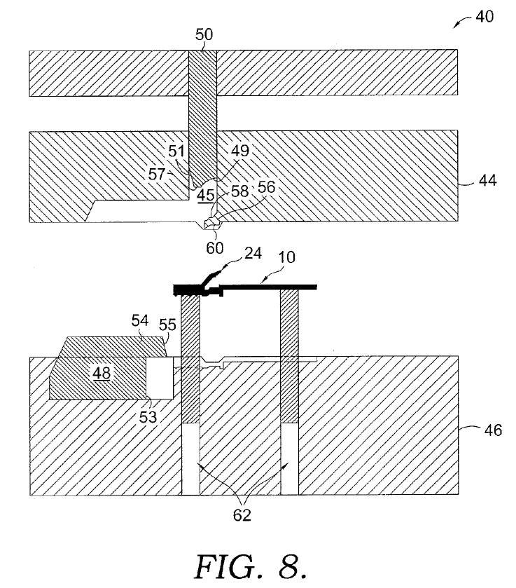

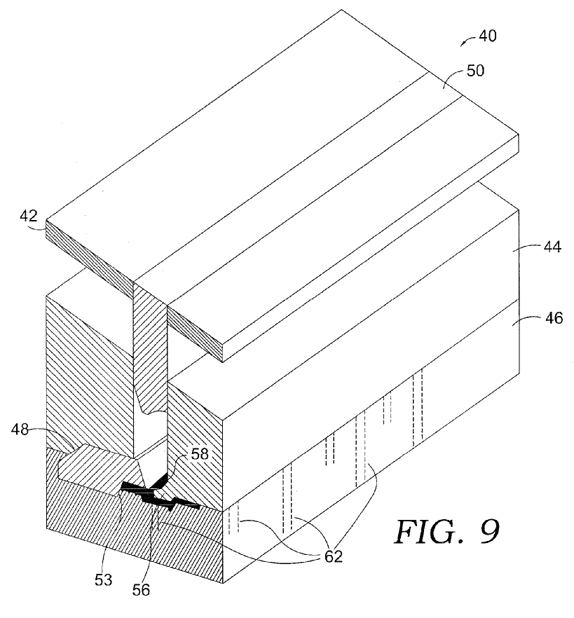

The final stage of separation is illustrated in FIG. 8. In the final stage of separation the slide 48 is moved transverse to direction of mold separation, in a relative lateral direction away from the cavity 52 and the newly molded panel 10. The panel 10 having the interlock tab 24 can then be ejected and removed from the mold assembly 40.

In another embodiment of the present invention, immediately following part ejection, a robot is utilized to clamp down the tab 24. The clamping of the tab 24 repositions the tab 24 to compensate for deformation that may result from the flexing of the tab 24 during retraction of the second mold half 44.

In yet another embodiment, the molded panel 10 is further controlled by utilizing the robot and also reheating the panel 10. The panel 10 is placed on a conveyor and is exposed to a heated conveyor oven to initiate secondary crystallization. By raising the temperature of the panel 10 to the crystallization point or temperature, the tab 24 will be formed to the final described shape.

The present invention provides an advantageous apparatus and method, comprising multiple mold elements and a sequential separation of the mold elements, in a molding technique that forms in place, extracts and prevents damage to a tab, on a newly molded part.

Another advantage of the present invention is the elimination of a manufacturing step, in which a folding and welding of a newly molded part was required. A further advantage is in the cost savings, and efficiencies that are achieved without impacting the quality or specifications of the end product.

The constructions described above and illustrated in the drawings are presented by way of example only and are not intended to limit the concepts and principles of the present invention. As such, it will be appreciated by one having ordinary skill in the art that various changes in the elements and their configuration and arrangement are possible without departing from the spirit and scope of the present invention as set forth in the claims.

From the foregoing, it will be seen that this invention is one well adapted to attain all the ends and objects hereinabove set forth together with other advantages which are obvious and which are inherent to the method and apparatus. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. As used herein, the terms “having” and/or “including” and other terms of inclusion are terms indicative of inclusion rather than requirement.

What is claimed is:

1. An apparatus for forming an injection molded part with an undercut, said undercut lying generally in a plane of a major portion of the part, said undercut having an open elongate opening and being positioned between an elongate integrally molded tongue and panel, said apparatus comprising;
a first mold half with a parting line first surface and a first mold cavity defining surface;
a second mold half with a parting line second surface and a second mold cavity defining surface;
a tongue member carried by the second mold half and projecting into the mold cavity when the parting line first and second surfaces are in contact, said tongue member having generally oppositely facing surfaces spaced from the first and second mold cavity defining surfaces for forming opposite faces of a molded part undercut;
a transverse mold insert movably carried by the second mold half and having a distal end portion forming a portion of the second mold cavity defining surface and overlying and spaced from one of the tongue surfaces forming a mold cavity portion therebetween; and
means to selectively effect movement of the transverse mold insert relative to at least a portion of the remainder of the second mold half.

2. The apparatus of claim 1 including a slide movably carried by the first mold half and having a third surface portion overlying and spaced from a portion of the first mold cavity defining surface to retain a part in the cavity when the mold halves separate.

3. An apparatus as in claim 1, wherein said third surface portion of said slide, along with an opposing portion of said first mold half define a region in said cavity for forming a nail hem.

4. An apparatus for forming in a single molding process in a mold, a part having an undercut, the undercut partially defined by a tab spaced from a panel portion the part and lying generally in a plane of a major portion of the part, the apparatus comprising:
multiple moveable mold elements, said moveable mold elements adapted to fit together to define a cavity to form the part, said moveable mold elements adapted to be separable in a particular sequence to free the molded part;
means to selectively effect movement of said multiple moveable mold elements; and
an ejector mechanism for releasing the part from the mold;
said multiple moveable mold elements comprising:
a first mold half having a first mold cavity defining surface to match at least a portion of one side of the part;
a second mold half having second mold cavity defining surface and a tongue with generally oppositely facing surfaces spaced from said first and second mold cavity defining surfaces for forming opposite faces of a molded part undercut;
a slide having a third surface portion overlying and spaced from a portion of the first mold cavity defining surface; and
an elongate transverse insert, said insert having a distal end portion forming a portion of the second mold cavity defining surface, said insert moveably located in said second mold half.

5. An apparatus as in claim 4, wherein said undercut is partially defined by the tongue in said second mold half.

6. An apparatus as in claim 4, wherein said mold cavity is shaped to form a said part in the form of a siding panel.

7. An apparatus as in claim 6, wherein said third surface portion of said slide, along with an opposing portion of said first mold half define a region in said cavity shaped to form a nail hem.

8. An apparatus as in claim 4, wherein said elongate transverse insert is movedly receiveable in an elongated opening in said second mold half, said elongate transverse insert having a first insert surface portion adapted to achieve a tight fit to a surface portion of said slide, without locking the pieces together, when the mold is in a closed position.

9. A method for forming an injection molded part with an undercut, the undercut and part being formed in a closed mold, the method comprising:
providing a mold having multiple components, wherein said multiple components include a first mold half, a second mold half, a transverse mold insert and a slide;
wherein said first mold half, second mold half, mold insert, and slide define a cavity when said mold is in the closed position; said second mold half having a tongue portion for defining the undercut;
injecting a material into said cavity;
holding said material for a period of time until said part is formed with said undercut;
moving in a sequential order said multiple components, to free the part for ejection; and ejecting said part.

10. The method of claim 9 wherein said sequential moving order begins with moving the insert element, followed by moving the second mold half and then moving the slide.

11. The method of claim 10 wherein moving of said second mold half is by motion that is non-lateral relative to the plane of the part.

12. The method of claim 10 wherein said moving of said second mold occurs in a direction that is normal to the plane of the part.

13. The method of claim 12 further comprising forming a tab, said tab spaced from the part by said undercut, the tab having an incident angle to the general plane of said part, whereby the moving of said second mold half causes the tongue on said second mold to flex said tab increasing said incident angle, said tab returning to said incident angle after the movement of said second mold half is complete.

14. The method of claim 10, wherein moving of said slide is by a lateral motion relative to the general plane of the part, to free the part.

15. The method of claim 9 wherein moving said multiple components includes moving the tongue past a tab forming portion of the undercut while bending the tab within its elastic limit, allowing the tab to return to its molded position.

16. An apparatus for forming in a single molding process, a part having a tab, said tab restricting movement of the part in a direction parallel to the plane of the part, the apparatus comprising:
a first mold half with a parting line first surface and a first mold cavity defining surface;
a slide having an overlying surface portion spaced from a portion of said first mold cavity defining surface;
a second mold half with a parting line second surface and a second mold cavity defining surface, having a tongue member projecting into a mold cavity, and having a moveable elongate transverse insert, said elongate transverse insert having a distal end spaced from said tongue member for defining a tab cavity portion therebetween, for forming the tab;
said mold cavity defined by said first mold cavity defining surface, said second mold cavity defining surface, said overlying surface portion of said slide, and a portion of said distal end of said elongate transverse insert, and said tab cavity portion;
wherein said cavity can receive and hold material for a time period to allow the part to form; and
wherein said slide, said first mold half, and said second mold half are moveable to allow removal of the part from the mold.

17. A method for forming an injection molded part having a tab molded in place, the method comprising:
providing a mold system having a first mold half with a first mold cavity defining surface, a second mold half with a second mold cavity defining surface, and a slide, said slide having an overlying portion, said second mold half having a tongue portion, a retaining portion for holding said slide in position and a elongate transverse mold insert with a distal third mold cavity defining surface position, said overlying portion, said first mold cavity defining surface, said second mold cavity defining surface and said third mold cavity defining surface defining a cavity wherein a portion of said third mold cavity defining surface and a surface of said tongue portion defining a tab cavity region coextensive with said cavity;
injecting a molten material into said cavity and tab cavity region;
holding said molten material for a period of time until said article is formed with a tab;
moving in a sequential order said first mold half, said second mold half and said slide; and
ejecting said part, wherein moving said second mold half flexes said tab while said slide retains the part in place, said tab returning to the its molded position after said second mold half is moved.
